(19) United States
(12) Patent Application Publication
(10) Pub. No.: US 2020/0082293 A1
(43) Pub. Date: Mar. 12, 2020

(54) PARTY-SPECIFIC ENVIRONMENTAL INTERFACE WITH ARTIFICIAL INTELLIGENCE (AI)

(71) Applicant: Every Life Works, LLC, Ellicott City, MD (US)

(72) Inventor: Somnath Sengupta, Ellicott City, MD (US)

(21) Appl. No.: 16/124,016

(22) Filed: Sep. 6, 2018

(51) Int. Cl. G06N 20/00; G06N 3/00; G06N 5/04; G06F 3/01

(52) U.S. Cl. CPC G06N 20/00; G06N 3/008; G06F 2203/011; G06F 3/011; G06N 5/04

(57) ABSTRACT

The buddy system is a procedure in which two people, the “buddies”, operate together as a single unit so that they are able to monitor and help each other. Webster goes on to define the buddy system as “an arrangement in which two individuals are paired (as for mutual safety in a hazardous situation). The buddy system is basically working together in pairs where both the individuals have to do the job. The job could be to ensure that the work is finished safely or the skill/learning is transferred effectively from one individual to the other. So whether it is for the disabled population or the warfighter or the elderly population, an effective buddy system will be very helpful to learn skills and execute them. An environmental interface device includes: an individual interface; an environment interface; and a set of sensors.

### BACKGROUND

The buddy system is a procedure in which two people, the “buddies”, operate together as a single unit so that they are able to monitor and help each other. Webster goes on to define the buddy system as “an arrangement in which two individuals are paired (as for mutual safety in a hazardous situation). The buddy system is basically working together in pairs where both the individuals have to do the job. The job could be to ensure that the work is finished safely or the skill/learning is transferred effectively from one individual to the other. So whether it is for the disabled population or the warfighter or the elderly population, an effective buddy system will be very helpful to learn skills and execute them.

There do not exist enough human beings who may have the qualifications for being a buddy.

Thus there is a need for a device that is able to grow and learn along with a particular individual to provide a lifelong support and feedback mechanism.

### SUMMARY

Some embodiments may provide an environmental interface device. The device may be directed toward use with a particular individual. The device may be associated with various appropriate operating environments ranging from real-world interactions to virtual reality (VR), augmented reality (AR), etc.

The device may include an individual interface (II) and an environmental interface (EI). The II may include various user interface (UI) elements and/or sensors that may be able interact with the particular individual and/or collect data related to a perceived emotional state of the individual and/or other response data associated with the individual. The EI may include similar UI elements and/or sensors that may be able to interact with other entities and/or collect data related to the environment or other entities within the environment.

The interface device may include various robotic and/or humanoid elements. In virtual environments, the device may be associated with one or more avatars or similar representations. Such elements may be able to provide stimuli to a human subject (e.g., by mimicking body language cues, by generating facial expressions, or performing partial tasks, etc.). Responses to such stimuli may be collected and analyzed. Other such elements may allow the interface device to move about the environment, collect data related to the environment, and/or otherwise interact with the environment, as appropriate.

Response information may be collected using various UI elements and/or sensors included in some embodiments. Such sensors may include, for instance, biometric sensors, cameras or motion sensors, etc. Response information may be collected via the II and/or EI. In virtual environments, such information may be collected via virtual sensors or other appropriate ways (e.g., by requesting environment information from an environment resource).

In addition to the interface device, a system of some embodiments may include one or more robot or android devices, user devices, servers, storages, other interface devices, etc. Such devices may include, for instance, user devices such as smartphones, tablets, personal computers, wearable devices, etc. Such devices may be able to interact across physical pathways, virtual pathways, and/or communication pathways. Communication channels may include wired connections (e.g., universal serial bus or USB, Ethernet, etc.) and wireless pathways (e.g., cellular networks, Bluetooth, Wi-Fi, the Internet, etc.).

Some embodiments may identify events and/or generate responses or cues associated with such identified events. Events may be identified by comparing sensor data, II data, EI data, and/or other collected data to various sets of evaluation criteria. Such criteria may be generated via artificial intelligence (AI) or machine learning in some embodiments.

Responses may utilize various UI elements and/or communication pathways to interact with the appropriate entity or object. Cues may be directed at the particular individual. Such cues may include event responses and/or more generalized feedback.

In addition to real-time feedback related to events and responses, some embodiments may be able to analyze collected data and provide generalized feedback related to lifestyle, behavior, etc., where the feedback may be applicable with or without identification of any specific event(s).

The device may implement various AI and/or machine learning algorithms. Such learning algorithms may be able to evaluate collected environment data, event data, response data, user data, and/or other appropriate data. The collected data may be analyzed using the various learning algorithms in order to implement updates to the learning algorithms, operating algorithms, operating parameters, and/or other relevant data that may be applied to the interface device and/or system.

Any updates to algorithms, operating parameters, etc. identified by such AI may be distributed to the various interface devices (and/or other system elements) in order to improve future performance.

In addition to generic learning and updates, some embodiments may apply the AI algorithms to the particular individual. Thus, as the individual grows and matures, the device may continuously update the various algorithms and/or operating parameters to match the observed data associated with the individual within a relevant time period.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a schematic block diagram of an interface device according to an exemplary embodiment;

FIG. 2 illustrates a schematic block diagram of a system that includes the interface device of FIG. 1;

FIG. 3 illustrates a schematic block diagram of an operating environment including the interface device of FIG. 1;

FIG. 4 illustrates a flow chart of an exemplary process that collects interaction data, applies machine learning, and generates operating updates;

FIG. 5 illustrates a flow chart of an exemplary process that provides real-time interactive environmental management for a user;

FIG. 6 illustrates a flow chart of an exemplary process that generates user feedback for individuals and groups of users; and

FIG. 7 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a party-specific environmental interface with artificial intelligence (AI).

A first exemplary embodiment provides an environmental interface device comprising: an individual interface; an environment interface; and a set of sensors.

A second exemplary embodiment provides an automated method of providing an environmental interface, the method comprising: receiving data from an individual interface; receiving data from an environmental interface; receiving data from a set of sensors; and storing the received data.

A third exemplary embodiment provides an environmental interface system comprising: an environmental interface device; a user device; and a server.

Several more detailed embodiments are described in the sections below. Section I provides a description of hardware architectures used by some embodiments. Section II then describes methods of operation implemented by some embodiments. Lastly, Section III describes a computer system which implements some of the embodiments.

### I. Hardware Architecture

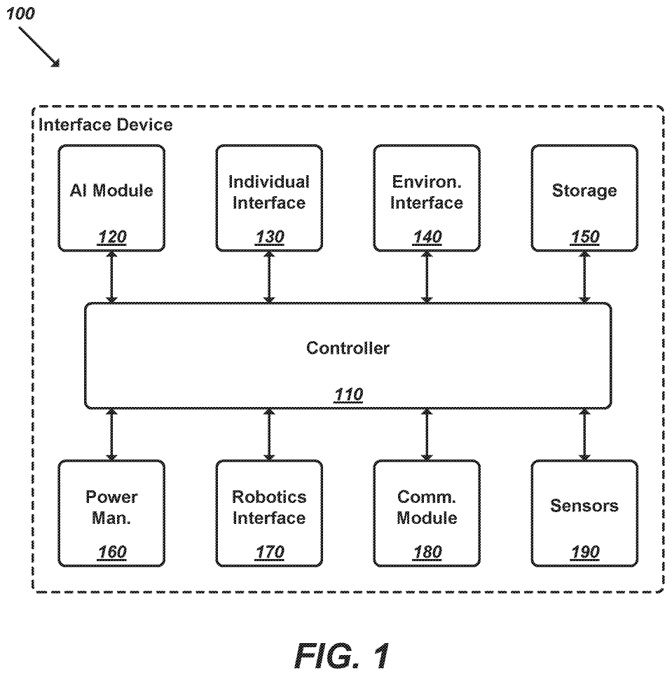

FIG. 1 illustrates a schematic block diagram of an interface device 100 according to an exemplary embodiment. As shown, the device may include a controller 110, an AI module 120, an individual interface 130, an environmental interface 140, a storage 150, a power management module 160, a robotics interface 170, a communication module 180, and various sensors 190.

The controller 110 may be an electronic device such as a processor, microcontroller, etc. that is capable of executing instructions and/or otherwise processing data. The controller may include various circuitry that may implement the controller functionality described throughout. The controller may be able to at least partly direct the operations of other device components.

The AI module 120 may include various electronic circuitry and/or components (e.g., processors, digital signal processors, etc.) that are able to implement various AI algorithms and machine learning.

The individual interface (II) 130 may include various interface elements related to usage by a particular individual that is associated with the device 100. The II 130 may include various user interface (UI) elements, such as buttons, keypads, touchscreens, displays, microphones, speakers, etc. that may receive information related to the individual and/or provide information or feedback to the individual. The II may include various interfaces for use with various environments, including virtual reality (VR), augmented reality (AR), mixed reality (MR). Such interfaces may include avatars for use within such environments. Such interfaces may include, for instance, goggles or other viewing hardware, sensory elements, haptic feedback elements, and/or other appropriate elements. The II may work in conjunction with the robotics interface 170 and/or sensors 190 described below.

The environmental interface (EI) 140 may be similar to the II 130, where the EI 140 is directed toward individuals (or other entities) that may be encountered by the particular individual associated with the device 100. The EI 140 may include UI elements (e.g., keypads, touchscreens, speakers, microphones, etc.) that may allow the device 100 to interact with various other individuals or entities. The EI 140 may work in conjunction with the robotics interface 170 and/or sensors 190 described below.

The storage 150 may include various electronic components that may be able to store data and instructions.

The power management module 160 may include various elements including charging interfaces, power distribution elements, battery monitors, etc.

The robotics interface 170 may include various elements that are able to at least partly control various robotic features associated with some embodiments of the device 100. Such robotics features may include movement elements (e.g., wheels, legs, etc.), expressive elements (e.g., facial expression features, body positioning elements, etc.), and/or other appropriate elements. Such robotics features may include life-like humanoid devices that are able to provide stimuli to the particular user or other entities.

The communication module 180 may be able to communicate across various wired and/or wireless communication pathways (e.g., Ethernet, Wi-Fi, cellular networks, Bluetooth, the Internet, etc.).

The sensors 190 may include various specific devices and/or elements, such as cameras, environmental sensors (e.g., temperature sensors, pressure sensors, humidity sensors, etc.), physiological sensors (e.g., heart rate monitors, perspiration sensors, etc.), facial recognition sensors, etc. During operation, the robotics features may be used to generate various stimuli and subject responses may be evaluated based on physiological reactions and/or emotional responses.

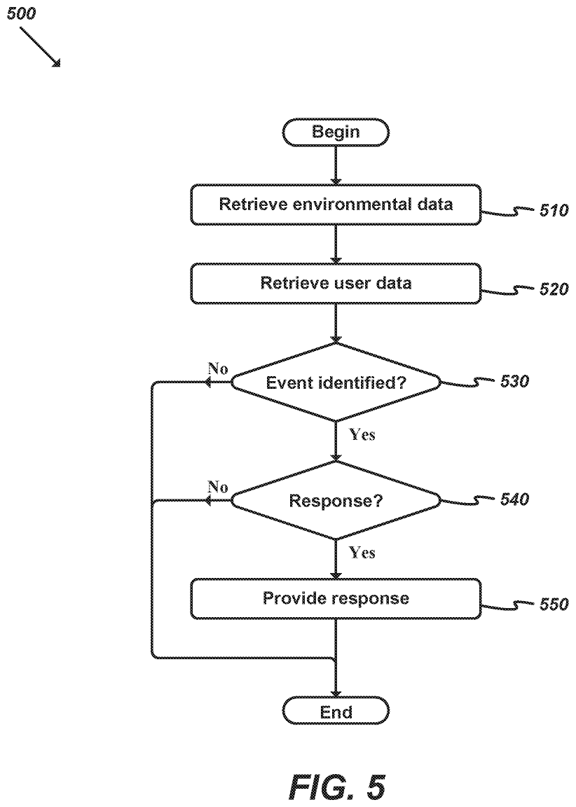

Operation of device 100 will be described in more detail in reference to FIG. 5-FIG. 7 below.

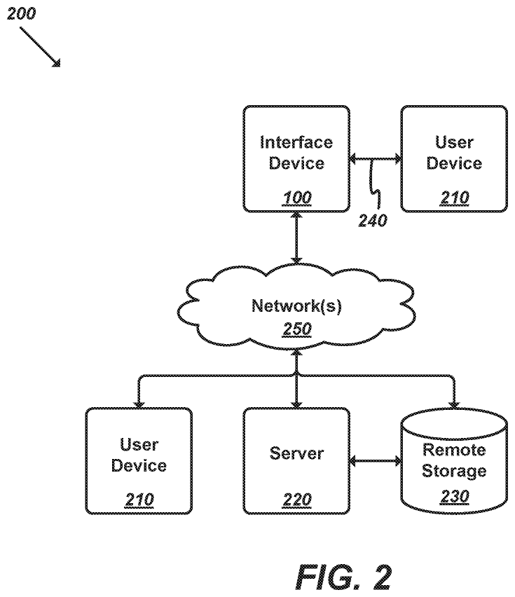

FIG. 2 illustrates a schematic block diagram of a system 200 that includes the interface device 100. As shown, the system 200 may include the interface device 100, one or more user devices 210, servers 220, and storages 230. The system 200 may utilize local communication pathways 240 and/or network pathways 250.

Each user device 210 may be a device such as a smartphone, tablet, personal computer, wearable device, etc. The interface device 100 may be able to communicate with user devices 210 across local channels 240 (e.g., Bluetooth) or network channels 250. In some embodiments, user devices 210 may provide data or services to the device 100. For instance, the user device 210 may include cameras, sensors, UI elements, etc. that may allow the particular individual and/or other entities to interact with the device 100.

Each server 220 may include one or more electronic devices that are able to execute instructions, process data, etc. Each storage 230 may be associated with one or more servers 220 and/or may be accessible by other system components via a resource such as an application programming interface (API).

Local pathway(s) 240 may include various wired and/or wireless communication pathways. Network(s) 250 may include local networks or communication channels (e.g., Ethernet, Wi-Fi, Bluetooth, etc.) and/or distributed networks or communication channels (e.g., cellular networks, the Internet, etc.).

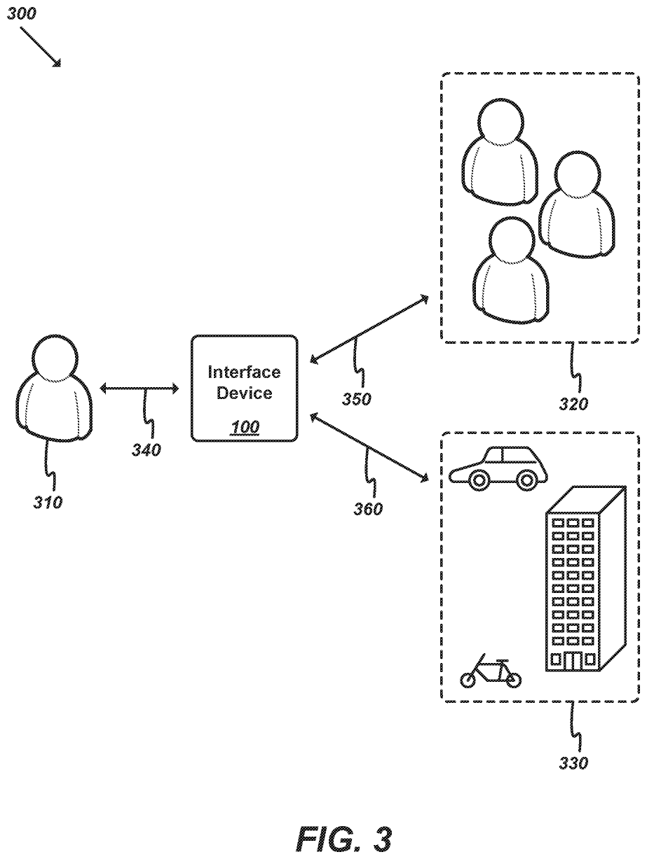

FIG. 3 illustrates a schematic block diagram of an operating environment 300 including the interface device 100. As shown, the environment may include a device user 310, an interface device 100, various other individuals 320, various objects 330, and various interaction pathways or interfaces 340-360.

The user 310 may be the particular individual associated with the device 100. The user 310 may be associated with an avatar or other similar element depending on the operating environment (e.g., AR, VR, etc.).

The individuals 320 may include various other sentient entities that may interact with the device 100. Such individuals 320 may include, for instance, people, pets, androids or robots, etc.

The objects 330 may include various physical features that may be encountered by a user 310 during interactions that utilize device 100. Such objects 330 may include virtual or rendered objects, depending on the operating environments. The objects 330 may include, for instance, vehicles, buildings, roadways, devices, etc.

Interface 340 may be similar to II 130 described above. Interface 350 and interface 360 may together provide features similar to those described above in reference to EI 140.

One of ordinary skill in the art will recognize that the devices and systems described above may be implemented in various different ways without departing from the scope of the disclosure. For instance, the various modules, elements, and/or devices may be arranged in various different ways, with different communication pathways. As another example, additional modules, elements, and/or devices may be included and/or various listed modules, elements, and/or devices may be omitted.

### II. Methods of Operation

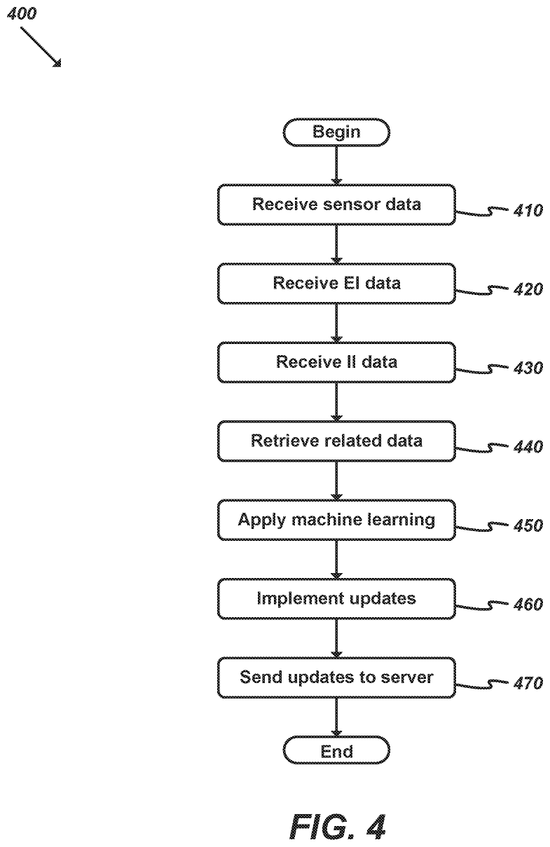

FIG. 4 illustrates a flow chart of an exemplary process 400 that collects interaction data, applies machine learning, and generates operating updates. Such a process may be executed by a resource such as interface device 100. Complementary process(es) may be executed by user device 210, server 220, and/or other appropriate elements. The process may begin, for example, when an interface device 100 is activated, when an application of some embodiments is launched, etc.

As shown, the process may receive (at 410) sensor data. Such data may be retrieved from elements such as sensors 190.

Next, the process may receive (at 420) EI data. Such data may be retrieved from a resource such as EI 140.

Process 400 may then receive (at 430) II data. Such data may be retrieved from a resource such as II 130.

Next, the process may retrieve (at 440) related data. Such related data may be retrieved from a resource such as server 220. The data may include, for instance, data associated with users having similar characteristics (e.g., biographic information, location, etc.) or experiences (e.g., workplace, grade or school, etc.).

The process may then apply (at 450) machine learning to the retrieved data. Such learning may include, for instance, statistical analysis. Based on the learning, the process may then implement (at 460) various updates. Such updates may include updates to operating parameters, algorithms, etc.

The process may then send (at 470) any identified updates to the server and then may end. In addition, the process may send any other collected data (e.g., environmental data, stimulus data, response data, etc.). Such collected data may be analyzed at the server in order to provide updates to various related users.

FIG. 5 illustrates a flow chart of an exemplary process 500 that provides real-time interactive environmental management for a user. Such a process may be executed by a resource such as interface device 100. Complementary process(es) may be executed by user device 210, server 220, and/or other appropriate elements. The process may begin, for example, when an interface device 100 is activated, when an application of some embodiments is launched, etc.

As shown, the process may retrieve (at 510) environmental data. Such data may include data collected from sensors 190, the EI 140, and/or other appropriate resources. Such data may include generic data (e.g., temperature, time of day, etc.) and/or entity-specific data (e.g., perceived mood of an individual, size or speed of an approaching object, etc.).

Next, the process may retrieve (at 520) user data. Such data may include biometric data, response data, perceived emotional state, etc.). Such data may be received via the II 130, sensors 190, and/or other appropriate resources.

The process may then determine (at 530) whether an event has been identified. Such an event may be identified by comparing the retrieved environmental and user data to various sets of evaluation criteria. For instance, an event may be identified when the user's 310 heart rate surpasses a threshold. Events may be related to the user 310, other entities 320 and/or other objects 330. If the process determines (at 530) that no event has been identified, the process may end.

If the process determines (at 530) that an event has been identified, the process may determine (at 540) whether a response to the event should be generated. Such a determination may be made in various appropriate ways. For instance, an identified event may be associated with various potential responses. If the process determines (at 540) that no response should be generated, the process may end. In such cases, the process may collect data related to circumstances surrounding the event and may store the data for future analysis and/or learning. Such data may also be provided to a resource such as server 220 or storage 230.

If the process determines (at 540) that a response should be generated, the process may provide (at 550) the response and then may end. Various responses may be generated depending on the circumstances surrounding the event, data related to the user 310, available resources for providing a response, etc. For example, if a user 310 is predicted to have an outburst or other undesirable response to an event, the device 100 may provide a parent's voice, music, video, and/or other stimulation known to be soothing to the user 310. As another example, the EI 140 may provide instructions to another individual 320 as to how to avoid an outburst or otherwise help manage responses of the user 310.

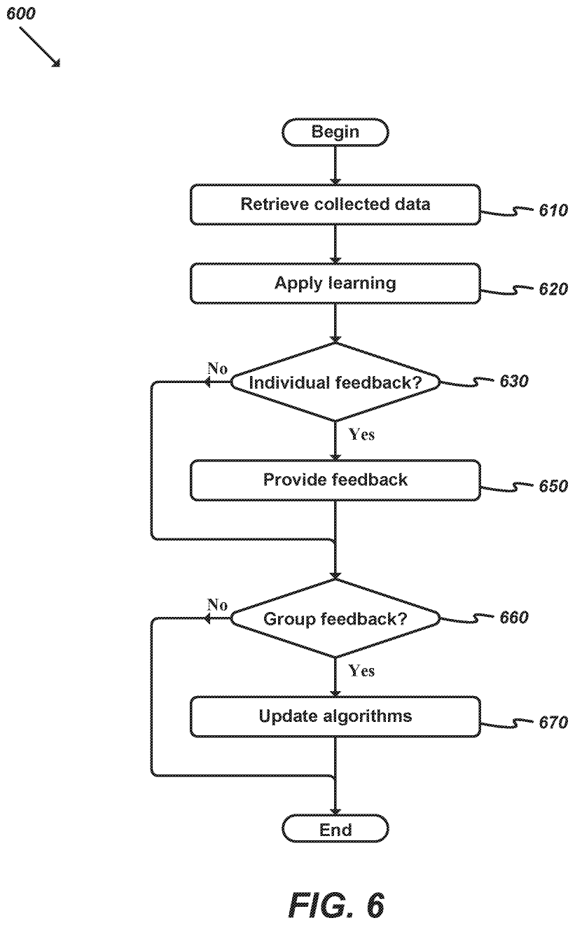

FIG. 6 illustrates a flow chart of an exemplary process 600 that generates user feedback for individuals and groups of users. Such a process may be executed by a resource such as interface device 100. Complementary process(es) may be executed by user device 210, server 220, and/or other appropriate elements. The process may begin, for example, when an interface device 100 is activated, when an application of some embodiments is launched, etc.

As shown, the process may retrieve (at 610) collected data. Such data may be related to a single user 310, groups of users, an event type, etc. Next, the process may apply (at 620) learning based on the collected data.

Next, the process may determine (at 630) whether there is any individual-specific feedback. Such a determination may be based on various appropriate AI algorithms. Such feedback may include, for instance, prediction of favorable occupational environments, recommendations for health and wellness, etc.

If the process determines (at 630) that there is feedback, the process may provide (at 650) the feedback. Such feedback may be provided through a resource such as II 130. The feedback may include identification of situations (e.g., lack of physical fitness for a soldier) and recommendations related to the identified situations (e.g., diet suggestions, sleep suggestions, training suggestions, etc.).

After determining (at 630) that there is no individual feedback or after providing (at 650) feedback, the process may determine (at 660) whether there is group feedback. Such a determination may be made using various appropriate AI algorithms. If the process determines (at 660) that there is group feedback, the process may update (at 670) various algorithms and then may end. Such algorithm update may include updates to algorithm operations, orders, weighting factors, and/or other parameters that may control operation of various AI features provided by some embodiments.

One of ordinary skill in the art will recognize that processes 400, 500, and 600 may be implemented in various different ways without departing from the scope of the disclosure. For instance, the various operations may be performed in different orders. As another example, additional operations may be included and/or various listed operations may be omitted. Furthermore, various operations and/or sets of operations may be executed iteratively and/or based on some execution criteria. Each process may be divided into multiple sub-processes and/or included in a larger macro process.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

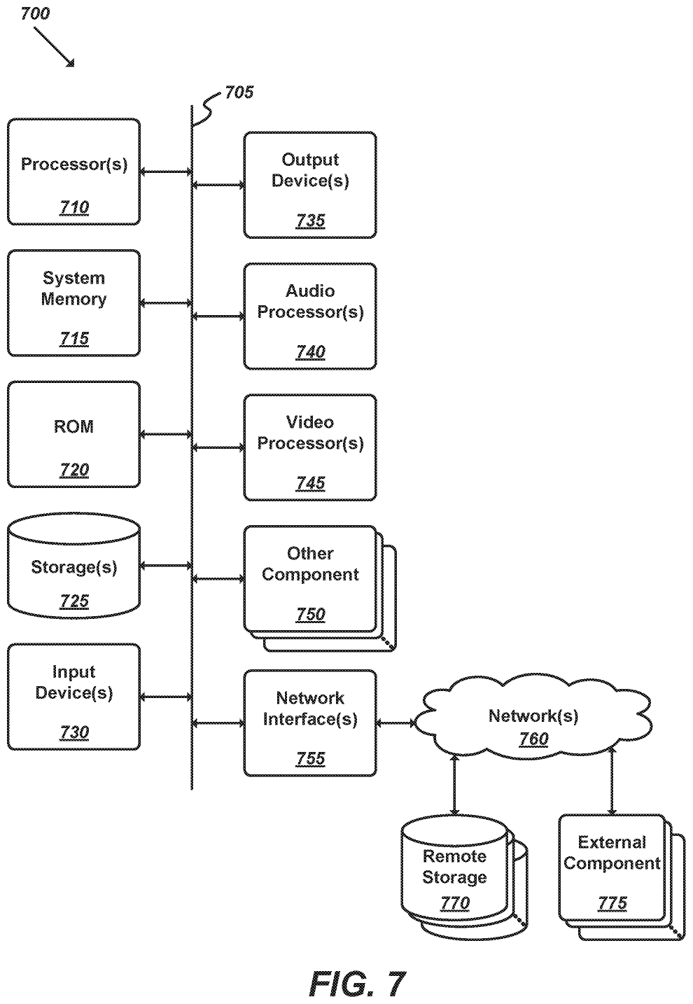

FIG. 7 illustrates a schematic block diagram of an exemplary computer system 700 used to implement some embodiments. For example, the system and/or devices described above in reference to FIG. 1, FIG. 2, and FIG. 3 may be at least partially implemented using computer system 700. As another example, the processes described in reference to FIG. 4, FIG. 5, and FIG. 6 may be at least partially implemented using sets of instructions that are executed using computer system 700.

Computer system 700 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 700 may include at least one communication bus 705, one or more processors 710, a system memory 715, a read-only memory (ROM) 720, permanent storage devices 725, input devices 730, output devices 735, audio processors 740, video processors 745, various other components 750, and one or more network interfaces 755.

Bus 705 represents all communication pathways among the elements of computer system 700. Such pathways may include wired, wireless, optical, and/or other appropriate communication pathways. For example, input devices 730 and/or output devices 735 may be coupled to the system 700 using a wireless connection protocol or system.

The processor 710 may, in order to execute the processes of some embodiments, retrieve instructions to execute and/or data to process from components such as system memory 715, ROM 720, and permanent storage device 725. Such instructions and data may be passed over bus 705.

System memory 715 may be a volatile read-and-write memory, such as a random access memory (RAM). The system memory may store some of the instructions and data that the processor uses at runtime. The sets of instructions and/or data used to implement some embodiments may be stored in the system memory 715, the permanent storage device 725, and/or the read-only memory 720. ROM 720 may store static data and instructions that may be used by processor 710 and/or other elements of the computer system.

Permanent storage device 725 may be a read-and-write memory device. The permanent storage device may be a non-volatile memory unit that stores instructions and data even when computer system 700 is off or unpowered. Computer system 700 may use a removable storage device and/or a remote storage device as the permanent storage device.

Input devices 730 may enable a user to communicate information to the computer system and/or manipulate various operations of the system. The input devices may include keyboards, cursor control devices, audio input devices and/or video input devices. Output devices 735 may include printers, displays, audio devices, etc. Some or all of the input and/or output devices may be wirelessly or optically connected to the computer system 700.

Audio processor 740 may process and/or generate audio data and/or instructions. The audio processor may be able to receive audio data from an input device 730 such as a microphone. The audio processor 740 may be able to provide audio data to output devices 740 such as a set of speakers. The audio data may include digital information and/or analog signals. The audio processor 740 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 745 (or graphics processing unit) may process and/or generate video data and/or instructions. The video processor may be able to receive video data from an input device 730 such as a camera. The video processor 745 may be able to provide video data to an output device 740 such as a display. The video data may include digital information and/or analog signals. The video processor 745 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 750 may perform various other functions including providing storage, interfacing with external systems or components, etc.

Finally, as shown in FIG. 7, computer system 700 may include one or more network interfaces 755 that are able to connect to one or more networks 760. For example, computer system 700 may be coupled to a web server on the Internet such that a web browser executing on computer system 700 may interact with the web server as a user interacts with an interface that operates in the web browser. Computer system 700 may be able to access one or more remote storages 770 and one or more external components 775 through the network interface 755 and network 760. The network interface(s) 755 may include one or more application programming interfaces (APIs) that may allow the computer system 700 to access remote systems and/or storages and also may allow remote systems and/or storages to access computer system 700 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 700 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

I claim:

1. An environmental interface device comprising:
an individual interface;
an environment interface; and
a set of sensors.

2. The environmental interface device of claim 1 further comprising an artificial intelligence module that:
collects data from the individual interface, environmental interface, and the set of sensors;
analyzes the data; and
updates at least one operating algorithm or operating parameter based on the data analysis.

3. The environmental interface device of claim 1, wherein the environmental interface device operates in at least one of a virtual reality, augmented reality, and mixed reality environment.

4. The environmental interface device of claim 1, wherein the individual interface comprises a set of user interface elements.

5. The environmental interface device of claim 1, wherein the environmental interface comprises a set of user interface elements.

6. The environmental interface device of claim 1, wherein the set of sensors includes at least one of a camera and a microphone.

7. The environmental interface device of claim 1 further comprising a set of humanoid robotic features able to generate at least one emotional stimulus.

8. An automated method of providing an environmental interface, the method comprising:
receiving data from an individual interface;
receiving data from an environmental interface;
receiving data from a set of sensors; and
storing the received data.

9. The automated method of claim 8 further comprising:
identifying at least one event based on the received data; and
generating a response to the at least one event.

10. The automated method of claim 8 further comprising:
applying artificial intelligence learning to the received data; and
updating at least one operating algorithm based on the applied artificial intelligence learning.

11. The automated method of claim 8 further comprising:
generating at least one emotional stimulus; and
identifying a response to the at least one emotional stimulus based on the received data.

12. The automated method of claim 8, wherein the individual interface comprises a set of user interface elements.

13. The automated method of claim 8, wherein the environmental interface comprises a set of user interface elements.

14. The automated method of claim 8, wherein the set of sensors includes at least one of a camera and a microphone.

15. An environmental interface system comprising:
an environmental interface device;
a user device; and
a server.

16. The environmental interface system of claim 15, wherein the environmental interface device comprises:
an individual interface;
an environment interface; and
a set of sensors.

17. The environmental interface system of claim 16, wherein the environmental interface device further comprises an artificial intelligence module that:
collects data from the individual interface, environmental interface, and the set of sensors;
analyzes the data; and
updates at least one operating algorithm or operating parameter based on the data analysis

18. The environmental interface system of claim 16, wherein the set of sensors includes at least one of a camera and a microphone.

19. The environmental interface system of claim 15, wherein the environmental interface system operates in at least one of a virtual reality, augmented reality, and mixed reality environment.

20. The environmental interface system of claim 15, wherein the user device is one of a smartphone, tablet, personal computer, and wearable device.
